(19) United States
(12) Patent Application Publication
(10) Pub. No.: US 2018/0136167 A1
(43) Pub. Date: May 17, 2018

(54) ACOUSTIC MEASUREMENT INFRASTRUCTURE METHOD AND SYSTEM FOR PROCESS MONITORING, DIAGNOSTICS, AND PROGNOSTICS

(71) Applicant: Battelle Energy Alliance, LLC, Idaho Falls, ID (US)

(72) Inventors: James A. Smith, Idaho Falls, ID (US); Vivek Agarwal, Idaho Falls, ID (US); James K. Jewell, Idaho Falls, ID (US)

(21) Appl. No.: 15/815,422

(22) Filed: Nov. 16, 2017

Related U.S. Application Data
(60) Provisional application No. 62/423,121, filed on Nov. 16, 2016.

(51) Int. Cl. G01N 29/036; G01N 29/22; F23N 5/08; F23N 5/16; G21C 17/112

(52) U.S. Cl. CPC G01N 29/036; G01N 29/222; F23N 5/08; F23L 2900/07003; G21C 17/112; G01N 2291/02881; F23N 5/16

(57) ABSTRACT

A method and system of acquiring and processing acoustic-based sensor data in real-time for process monitoring, diagnostics, and prognostics. The method comprises continuously capturing analog signal data; continuously digitizing the signal data; selecting a time interval of the digitized data; applying an STFFT to the data within the time interval; selecting a harmonic frequency to monitor; shifting the time interval by a percentage of the duration of the time interval; applying the STFFT to the data within the shifted time interval; and observing the data to determine whether the data have changed. The system comprises modules for acquiring analog signal data; digitizing the analog signal data as the data are acquired; displaying the data as the data are processed; recursively applying an STFFT to the data; displaying results of applying a STFFT to the data; applying an FFT to the data; and displaying results of applying an FFT to the data.

### PRIORITY CLAIM

This application claims the benefit of the filing date of U.S. Provisional Patent Application Ser. No. 62/423,121, filed Nov. 16, 2016, for “Acoustic Measurement Infrastructure Method and System for Process Monitoring, Diagnostics, and Prognostics,” the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates to methods and systems for process monitoring, diagnostics, and prognostics. More specifically, embodiments of the disclosure relate to methods and systems for acquiring and processing sensor data in real-time for process monitoring, diagnostics, and prognostics.

### BACKGROUND

One challenge for researchers in nuclear energy is to enhance the fundamental understanding of reactor fuel and material behavior subjected to intense irradiation. Traditionally, radiation-hardened sensors and their associated signal-conditioning electronics are used to study key parameters of fuel and materials inside the nuclear reactor core before and after irradiation. However, traditional approaches have limitations such as the inability to provide non-intrusive real-time measurements, the requirement of at least two wires to provide power and to communicate information from inside to outside the nuclear reactor vessel, and the degradation of the performance of sensors and their instrumentations/electronics over time, which can have an adverse effect on measurement accuracy and model predictions. Conventional process sensors monitor quasi-static variations and tend to filter dynamic events. For example, the extrusion process is very sensitive to pressure fluctuations/pulses caused by the cyclic turning of the screw in the extruder bore as well as rheology changes in the paste or melted plastic. Any extrusion process that has aggressive dimensional or density specifications for the product will be adversely affected by static and dynamic changes in pressure and rheology.

### BRIEF SUMMARY

An embodiment of the disclosure relates to a method and system of acquiring and processing sensor data in real-time for process monitoring, diagnostics, and prognostics. The method includes continuously capturing analog signal data from at least one sensor and digitizing the signal data, applying a Short Time Fast Fourier Transform (STFFT) to the digitized data within a selected time interval having a duration (T) to obtain a time-frequency spectrum, selecting at least one harmonic frequency to monitor from the time-frequency spectrum, recording an amplitude, frequency, and phase for the selected frequency from the time-frequency spectrum, applying the STFFT to the digitized data within a shifted time interval having a duration (T) and shifted by a percentage (X %) of T, recording an amplitude, frequency, and phase of the at least one harmonic frequency selected to be monitored from the time-frequency spectrum for the shifted time interval, and determining whether the analog signal data have changed and whether a condition is causing the analog signal data to change responsive to monitoring the amplitude, frequency, and phase data from the shifted time interval and the amplitude, frequency, and phase data for the previous time intervals.

An embodiment of the disclosure includes an acoustic measurement infrastructure system, comprising at least one sensor and a data acquisition system including a processor operably coupled to the at least one sensor. The processor is configured to acquire analog signal data from at least one sensor, digitize the analog signal data, convert the digitized analog signal data to obtain frequency information for the digitized signal data, select at least one harmonic frequency to monitor from the frequency information, record an amplitude, frequency, and phase for the selected frequency from the frequency information, apply the STFFT to the raw digitized data within a shifted time interval having a duration (T) and shifted by a percentage (X %) of T, record an amplitude, frequency, and phase of at least one harmonic frequency selected to be monitored from the time-frequency spectrum for the shifted time interval, and determine whether the analog signal data have changed and whether a condition is causing the analog signal data to change responsive to monitoring the amplitude, frequency, and phase data from the shifted time interval and the amplitude, frequency, and phase data for the previous time intervals.

### BRIEF DESCRIPTION OF THE DRAWINGS

FIG. 1 is a schematic diagram showing the nuclear reactor environment that may include an acoustic measurement infrastructure (AMI) system according to an embodiment of the disclosure.

FIG. 2 is a schematic block diagram of an AMI system.

FIG. 3 is a flowchart illustrating a method of acquiring and processing acoustic-based sensor data in real-time for process monitoring, diagnostics, and prognostics of a system.

FIG. 4 is a graph showing such raw acoustic data.

FIG. 5 shows FFT snapshots of signature data generated from different acoustic sensors coupled to different external structures of the nuclear reactor.

FIG. 6 shows FFT snapshots of signature data generated from different acoustic sensors coupled to different external structures of the nuclear reactor for different usage cycles.

FIGS. 7A-7C are recursive STFFT spectrograms for an operational time scale collected by the AMI.

FIGS. 8A and 8B are recursive STFFT spectrograms for an operational time scale collected by the AMI demonstrating a change of state during operation of the nuclear reactor that is detected by the AMI system.

### DETAILED DESCRIPTION

In the following description, reference is made to the accompanying drawings in which are shown, by way of illustration, specific embodiments in which the disclosure may be practiced. The embodiments are intended to describe aspects of the disclosure in sufficient detail to enable those skilled in the art to make, use, and otherwise practice the disclosure. Furthermore, specific implementations shown and described are only examples and should not be construed as the only way to implement the present disclosure unless specified otherwise herein. It will be readily apparent to one of ordinary skill in the art that the various embodiments of the present disclosure may be practiced by numerous other partitioning solutions. Other embodiments may be utilized and changes may be made to the disclosed embodiments without departing from the scope of the disclosure. The following detailed description is not to be taken in a limiting sense, and the scope of the present invention is defined only by the appended claims. Any drawings accompanying the present application are for illustrative purposes only and are not drawn to scale. Elements common among figures may retain the same numerical designation.

In the following description, elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art. A person of ordinary skill in the art will understand that some components are not described herein but that using various conventional components and acts would be in accord with the disclosure. In addition, the embodiments may be practiced in conjunction with conventional systems and methods used in the industry.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, e.g., a combination of a DSP and a microprocessor, a plurality of microprocessors, one or more microprocessors in conjunction with a DSP core, or any other such configuration.

Also, it is noted that embodiments may be described in terms of a process that may be depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media include both computer storage media and communication media, including any medium that facilitates transfer of a computer program from one place to another.

It should be understood that any reference to an element herein using a designation such as “first,” “second,” and so forth, does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

Embodiments may refer to an AMI within a nuclear reactor. Despite the hostile environment of a nuclear reactor for sensing and electrical communication, the nuclear reactor core may be amenable to telemetry and acoustic telemetry in particular. The present disclosure is directed toward methods and systems of acquiring and processing sensor data in real-time for process monitoring, diagnostics, and prognostics. For example, embodiments of the disclosure include active sensors, including acoustic sensors (e.g., thermo-acoustic sensors, vibro-acoustic sensors, etc.), intrinsic sensors formed by pressure pulses from pumps, and Radio-Frequency Identification (RFID) sensors to enable real-time and wireless (i.e., transmission of signals via fluids, mechanical structures, pipes, and conduits) in-pile measurement of key parameters such as temperature, flux, fuel-dimension changes, and fission gases.

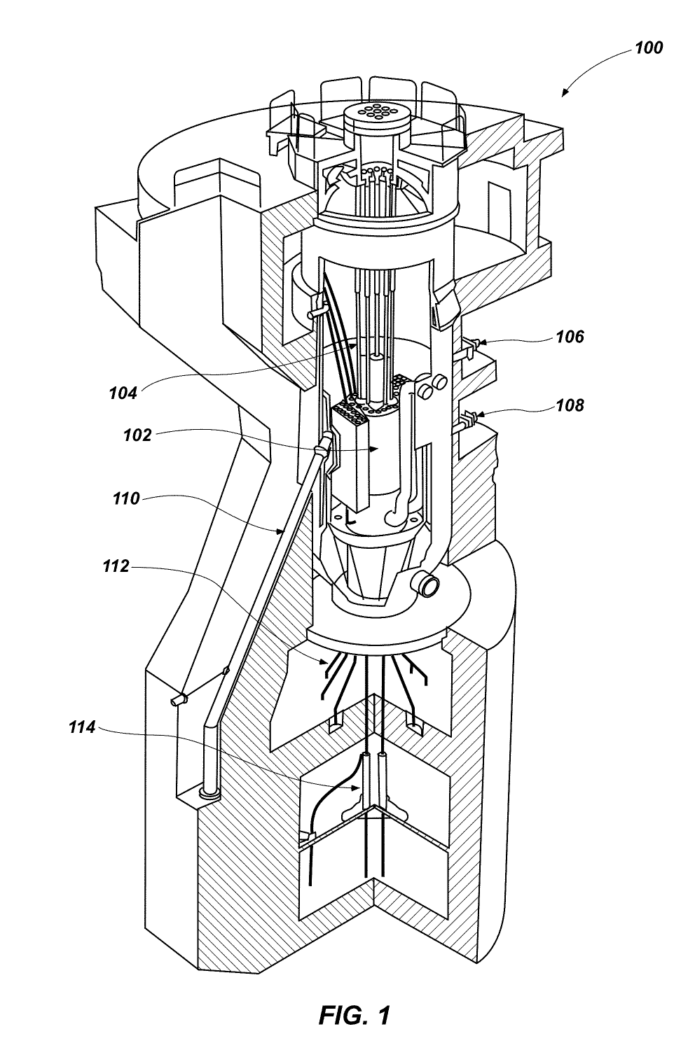

While much of the detailed description and examples of this disclosure are dedicated to use of an AMI system within a nuclear reactor (see, e.g., FIG. 1), other industries use processes such as extrusion, milling, mixing, drawing and pumping that could also benefit from non-intrusive monitoring using sensors, and are also contemplated as being within embodiments of the disclosure. Thus, embodiments of the disclosure include process monitoring system implemented within other industrial processes that are continuous or quasi-continuous. For example, continuous processes may include requirements of steady and accurate flow of raw materials and fluids as well as stable mixing processes. Such applications may include oil refining, petrochemical cracking, chemical reactors and synthesis, synthetic fibers, fertilizers, pulp and paper, blast furnace (iron), metal smelting, power stations, natural gas processing, sanitary waste water treatment, continuous casting of steel, rotary kilns for calcining lime or cement, float glass, display glass, extrusion (e.g., ceramic, plastics, paste), food processing, etc. Embodiments of the disclosure may be particularly useful in applications that involve large temperature gradients, hostile or corrosive environments, and/or hard to wire locations.

The ability to accurately measure and track salient process parameters may contribute to the continuous processes being effective. The AMI method and system can be used to monitor standard and non-standard process sensors for a given application. What is considered to be standard process sensors is industry specific; however, non-limiting examples include temperature, pressure, extension, strain, dilatometry, density, speed/feed rate, voltage, amperage, electro-magnetic, rheology, moisture, composition, motion (e.g., vibration, displacement), etc.

FIG. 1 is a schematic diagram showing the nuclear reactor 100 environment that may include an AMI system according to an embodiment of the disclosure. The nuclear reactor 100 may include a reactor core 102, in-pile tubes 104, outer shim cylinder drives 106, safety rod drives 108, a discharge chute 110, in-pile tubes 112 (entrance/exit piping), and regulating rod drives 114 among other components (e.g., coolant, coolant pumps, etc.).

With respect to the nuclear reactor 100 environment, the AMI relies on sources inside the nuclear reactor 100 generating information that is detected by sensors located outside of and/or within the nuclear reactor 100. The transmission of information may be generated via electrical leads, antennas, fluids (e.g., coolant, gas, water, liquid metal, etc.), mechanical structures (e.g., lattice work, generators, turning screws, control rods, pressure vessels, piping, and other conduits or structures acting as acoustic wave guides) of the nuclear reactor 100. The data sources may be cyclic in nature, or in some cases may be detected to deviate from cyclic behavior as part of the diagnostic or prognostic analysis. The AMI may be configured to monitor to the nuclear reactor's 100 intrinsic sources during operation (e.g., irradiation) using extrinsic sensors coupled to external structures of the nuclear reactor 100, such as on the exterior of the pressure vessel, on vessel piping, flanges, a hydraulic shuttle irradiation system (HSIS) (e.g., in the nozzle trench area for an advanced test reactor (ATR)), or other desirable external locations that are either easily accessible and/or close to one of the sources. The transmission/telemetry of signals will allow access to raw data, processing the data, and extracting information from the signal while the measurement is still in progress inside the nuclear reactor 100.

As a result, efficient non-intrusive in-pile measurements (e.g., temperature, axial extension, fission gases, neutron flux, gamma flux, etc.) may be enabled under different operating configurations by performing signal processing of the data measured by the sensors with a data acquisition system. Other phenomena, such as fuel motion, core barrel motion, individual fuel rod vibration, loose parts, thermal expansion, flow blockage, and coolant void fraction that occur inside the nuclear reactor 100 may also be extracted from the data during operation. Embodiments of the disclosure may also enable early detection of failures in structures, pump/vane degradation, and other diverse faults inside the nuclear reactor 100. Multiple signals from several receivers provide an ability to assess operating conditions with minimal impact on the nuclear reactor's 100 safety or control systems. In addition, the characteristics of the signal can indicate the process state of the ATR (such as reactor startup, reactor criticality, reactor attaining maximum power, and reactor shutdown) during operation. For example, a baseline signature is captured during normal operation cycle and detects any deviations from that baseline signature during a subsequent operation cycle. The signatures may include data for frequencies as well as amplitude and phase of the signals. The deviation from the baseline signature may be used to identify structural degradations earlier than through conventional methods.

The baseline signatures may be used in the design and development of actively telemetered sensors that are used for a specific environment. In particular, analyzing the sensor data may identify quiescent frequency ranges that can be used to enhance and/or tune the frequency of the telemetered sensor design prior to fabrication and installation to further enhance performance during operation.

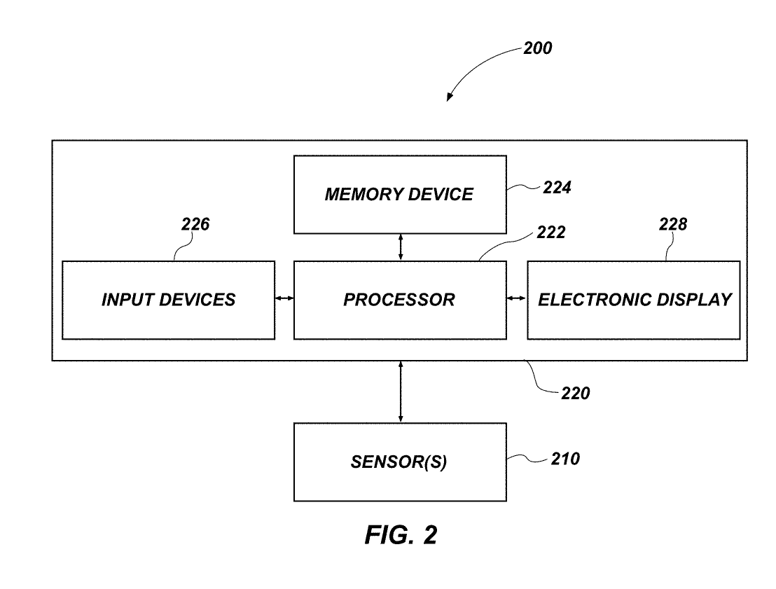

FIG. 2 is a schematic block diagram of the AMI 200 including sensors 210 and a data acquisition system (DAS) 220. The DAS 220 is configured to execute signal processing methods that enable real-time measurement of the signals generated by the sensors 210. Sensors 210 may include passive sensors (e.g., temperature, pressure, displacement, strain, vibrometers, microphones, accelerometers, etc.) configured to generate an analog voltage representative of the parameter being measured. The sensors 210 may also include active sensors such as acoustic based sensors (e.g., thermo-acoustic, vibro-acoustic, etc.), electromagnetic based sensors (e.g., RFID, etc.), intrinsic sensors derived from pressure pulses generated by pumps, screws, gears, pulleys, etc. In some embodiments, the active sensors may also be configured to generate a telemetered signal sent to an associated receiver for decoding and processing. Embodiments may also include a combination of different types of sensors, including a combination of both passive and active sensors.

The DAS 220 may include a processor 222 operably coupled with a memory device 224, input devices 226, and an electronic display 228. The processor 222 may coordinate the communication between the various devices as well as execute instructions stored in computer-readable media of the memory device 224. Input devices 226 may include devices such as a keyboard, touch screen interface, analog-to-digital converters, digital channels or other devices that are configured to receive information that may be used by the processor 222 to receive inputs from an operator of the DAS 220. The electronic display 228 may be configured to receive the data and output the information from the processor 222 for the operator to view and to store in the memory device 224. The DAS 220 may include components that are not shown in the figures, but may also be included to facilitate communication with the sensors 210 as would be understood by one of ordinary skill in the art, such as including one or more analog-to-digital converter, digital interfaces or channels, power sources, input ports (e.g., wired, wireless), etc. In some embodiments, the sensors 210 may be coupled with the input devices 226 to send/receive data and/or other control signals.

Sensors 210 may include sensors and telemetry receivers for active sensors. In some embodiments, the sensors may include piezoelectric accelerometers. As discussed above, the sensors 210 may be placed on external physical structures of a nuclear reactor to detect acoustic information from internal acoustic sources within the nuclear reactor. As a result, the transmission and detection of the acoustic signals may be wireless with regard to the acoustic waves being generated and telemetered within the nuclear reactor and the acoustic sensors and any associated cabling being located wholly outside of the nuclear reactor.

The DAS 220 may be configured to receive and demodulate thermo-acoustic and/or vibro-acoustic signals and/or pressure pulses from pumps telemetered from multiple active sensors 210. The active sensor data from multiple sensors and sensor types can be gathered simultaneously by frequency-division multiplexing for processing by a single sensor or multiple sensors.

The DAS 220 is configured automatically to convert telemetered sensor signals into dynamic measurement parameters, such as amplitude, frequency, and phase data. Thus, a single active sensor will be able to monitor at least three process measurements. The measurement parameters may be further indicative of other data (e.g., reactor temperature, axial extension, fission gases, microstructure, pressure fluctuation, etc.) derived by the DAS 220. For example, amplitude data in the telemetered thermo-acoustic signal may be proportional to neutron or gamma flux; frequency information may be proportional to temperature, and phase information can track axial elongation of the active sensor. The sensors 210 may be configured to be temperature sensors by monitoring the frequency of the telemetered acoustic standing wave, which may depend upon the effective temperature of the gas in the resonant chamber. The thermo-acoustic sensor can also be used to monitor the molecular mass of the gas mixture within the resonant chamber. Thus, the thermo-acoustic sensor can also be used to monitor the progress of chemical reactions. The AMI 220 can be extended to collect information on other phenomena, such as fuel motion, individual fuel rod vibration, loose parts, thermal expansion, and flow blockage that occur inside an operating nuclear reactor. The AMI 200 may also be configured to determine the acoustic baseline signatures of an ATR.

An embodiment of the disclosure includes a graphical user interface that is generated by the processor 222 of the DAS 220 for display to the electronic display 228. This interface may include icons to allow a user to perform operations such as initializing the DAS, starting signal data acquisition, stopping signal data acquisition, displaying acquired and processed data, and setting and modifying configuration settings. As an example, a trending screen of the graphical user interface may display scaled analog input data of all active channels for the various sensors 210.

The processor 222 may be configured to acquire analog signal data from sensors 210, digitize the analog signal data as the data are acquired, displaying the digitized data as the data are processed, apply a Fast Fourier Transform (FFT) (e.g., STFFT) to the digitized data, and display results of applying an FFT (e.g., STFFT) to the digitized data. The STFFT is composed from the recursive use of a shifted window FFT over a data set. The processor 222 may also be configured to create, display, and store in the memory device 224 an event log to maintain a list of system events that have occurred for a system data acquisition session and store FFT (e.g., STFFT) results in a file stored in the memory device 224. In some embodiments, the processor 222 may be configured to apply both an FFT and an STFFT to the digitized data, as well as display and store the results of both transforms.

The processor 222 may also be configured to establish acquisition parameters, such as the acquisition rate, time interval, number of samples to average, and which acquisition mode to use. The acquisition modes may include a continuous mode that runs when the user initiates the acquisition process, an “SWTrigger” mode that starts and ends the acquisition process when one or more pre-defined triggers are met, and a wakeup mode that starts and ends the acquisition process using pre-defined timers.

The processor 222 may also be configured to establish data processing modes. The data processing modes may include a normal mode that performs no data processing other than a rolling average, an FFT mode that performs, an FFT on incoming data after a set time window has elapsed, and an STFFT mode that that track harmonic center frequencies within a defined frequency bandwidth and can be considered to be a virtual STFFT channel configured to reference a physical channel. After each time shift of the time interval, an STFFT is performed on the data in the current time interval. The results are then searched for the largest peak amplitude to determine the harmonic frequency within the frequency bandwidth (range) defined for each STFFT channel. The corresponding frequency and phase are reported as well. The phase is unwrapped to avoid any jumps. This operation involves adding or subtracting 2π until the reported phase is within a distance of π from the previous reported phase.

The user may also be permitted to configure the analog input channels for all signals connected to data acquisition interface equipment. Channels can be added or deleted in this module. The address of the channel corresponds to the physical input that to which the signal is connected. The terminal configuration indicates whether the channel is single-ended or differential. For thermocouples, this module allows the thermocouple type to be selected. The min/max values indicate the range of the raw signal for this channel. For voltage channels, an exemplary range may be −10 V to 10 V and for current channels may be 0.004 A to 0.020 A. Other ranges are also contemplated. The scale and offset are used to convert the raw acquired value to engineering units. Plot type, line type, and symbol type dictate how the channel's data is displayed on the waveform chart.

The SWTrigger mode settings allow triggering events to be added or removed. In triggering mode, the application will wait for one of the user-defined trigger conditions to be met to begin logging data. The amount of data to be logged, both before and after the trigger event, can be specified in the DAS 220 as well. After a trigger has occurred and the specified amount of data (e.g., time interval) has been logged, the application may resume monitoring for trigger events and remain in this loop until stopped by the user. The data for each triggered acquisition may be saved to its own file.

The wakeup mode settings allow timer events to be added or deleted. When in wakeup mode, the DAS 220 can use a wakeup timer to start and end acquiring data. The timers can be configured to have a start time as well as a start date. The timer can be set to repeat as well, for example, every N minutes, hours, or days. The timer may also be set to a random value so that the timer will not start the data acquisition at the exact timer setting but rather at a random time near the setting, the range of which is determined by the random value setting. For example, a timer may be have the following settings: duration, 20 seconds; repeat every 5 minutes; start time, Jan. 1, 2016, at 12:00:00 AM; and random value of 0.25. In this case, the data acquisition may start for the first time on midnight, Jan. 1, 2016, and it would start again at 12:05 AM, and every 5 minutes from then on. However, the random value of 0.25, which represents 15 seconds, means the timer to go off any time between 12:04:52.5 AM and 12:05:07.5 AM (e.g., a 15 second range, centered on 12:05).

The virtual STFFT channel may be configured to monitor a certain range of frequencies on a specified channel. The target frequency is the median frequency being monitored for and the search window specifies the range around the target frequency that gets searched. Each STFFT channel may be plotted. The Y axis settings allow the user to configure the available Y axes for the system. The configured Y axes are then available to be selected for any of the analog input channels. For example, the auto range setting indicates that the y axis should automatically adjust its range to make all data visible for all associated channels.

The real-time conversion from sensor signal into effective process and microstructure characterization data from multiple locations in the nuclear reactor 100 (FIG. 1) may also enable control and diagnostic capabilities. Thus, the processor 222 may also be coupled to other control systems of the nuclear reactor such that different processes of the nuclear reactor may be controlled and adjusted responsive to the information derived from the sensor data.

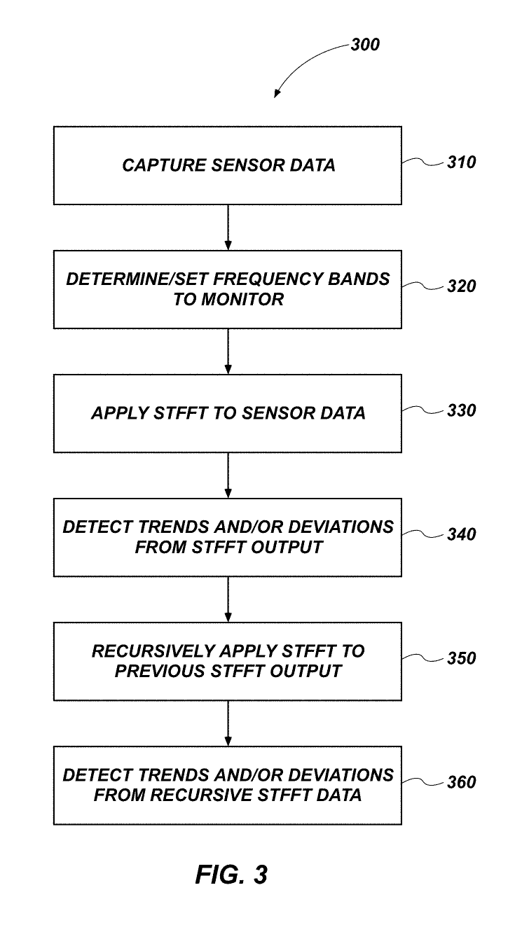

FIG. 3 is a flowchart 300 illustrating a method of acquiring and processing sensor data in real-time for process monitoring, diagnostics, and prognostics of a system (e.g., a nuclear reactor).

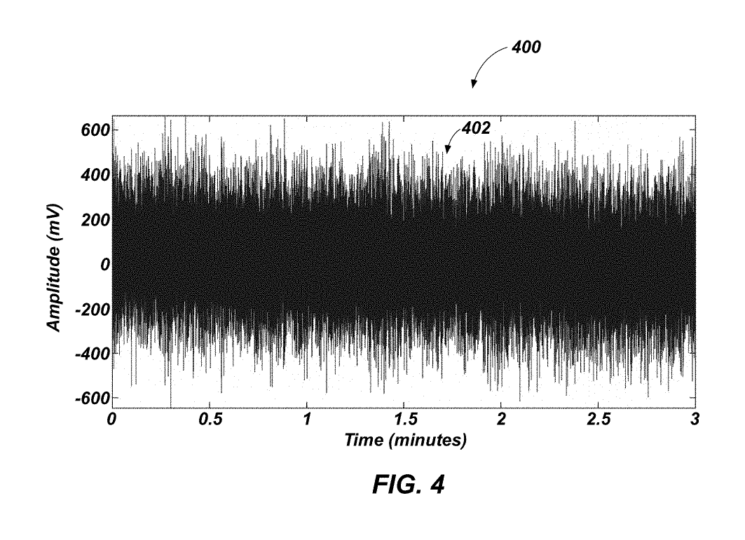

The method includes the steps of continuously capturing raw sensor data from at least one sensor (operation 310). Capturing the raw data may include capturing analog signal data and continuously digitizing the analog signal data. FIG. 4 is a graph 400 showing such raw sensor data 402.

The method further includes determining/setting the center frequencies and/or frequency bandwidths to monitor (operation 320). The frequency bands to monitor may be set by performing a Fast Fourier Transform (e.g., STFFT) on the digitized acoustic data to obtain frequency data to obtain a baseline signature in a first instance, and using the resulting spectrum to identify harmonic frequencies and frequency bands to monitor, selecting a fundamental harmonic frequency to monitor, and/or selecting the frequency with the largest amplitude to monitor as examples. An STFFT is then performed on the incoming sensor data (operation 330) and the resulting information may be stored for subsequent comparison of one or more of these characteristic baseline data points to real-time operational data to determine any trends and/or deviations from the baseline signature (operation 340).

If the STFFT output is varying, it may be appropriate to recursively apply the STFFT to previous STFFT output. The STFFT transform can be recursively applied to the previous STFFT amplitude, phase and frequency output (operation 350). The resulting data from the recursive use of the STFFT can then be used to detect trends and/or deviations from the Recursive STFFT output (operation 360). Operations 350 and 360 can be recursively applied a number of times as desired (or not at all in some instances).

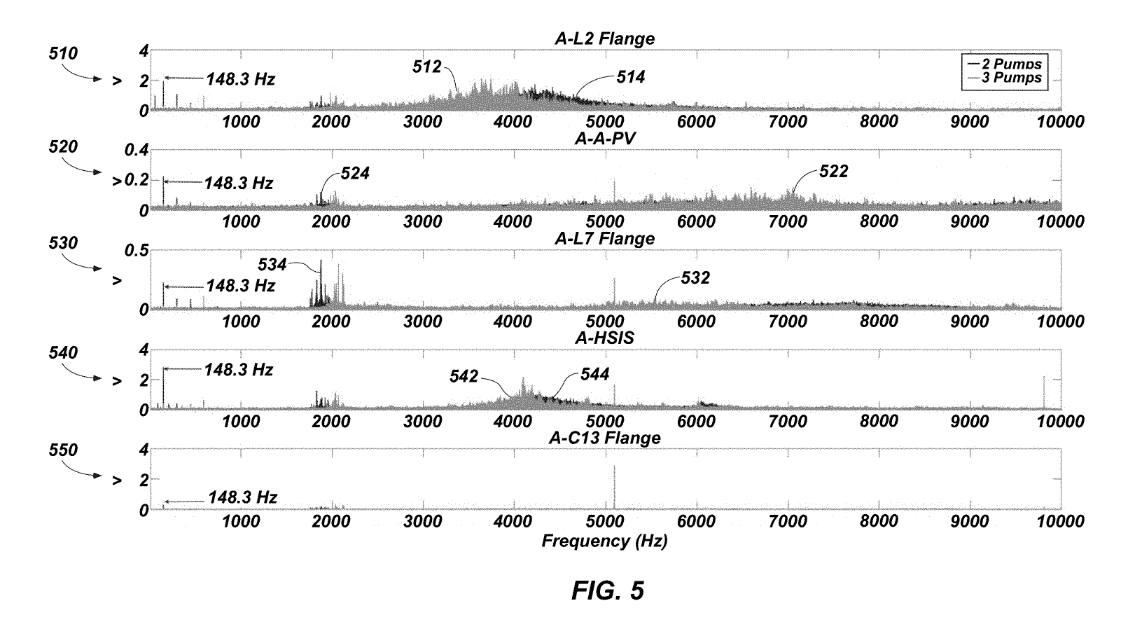

As an example, FIG. 5 shows FFT snapshots 510-550 of signature data generated from different acoustic sensors coupled to different external structures of the nuclear reactor. A fundamental frequency harmonic of 148.3 Hz (Hertz) caused by the rotating pump vanes is detected by each of the acoustic sensors. As a result, this harmonic frequency (along with its amplitude at each sensor) may be monitored during real-time operation to determine any amplitude changes and/or frequency shifts that may indicate some deviation from the baseline signature. Other data sets 512, 514, 524, 522, 532, 534, 542, 544 may correspond to different acoustic sources that are detectable by the respective sensors for different operation configurations. In some situations, the system may be able to distinguish between multiple operation configurations of acoustic sources based on analyzing the acoustic data trends over time, such as being able to distinguish between two pumps operating (data sets 514, 524, 534, 544) and three pumps operating (data sets 512, 522, 532, 542) based on the frequency signatures.

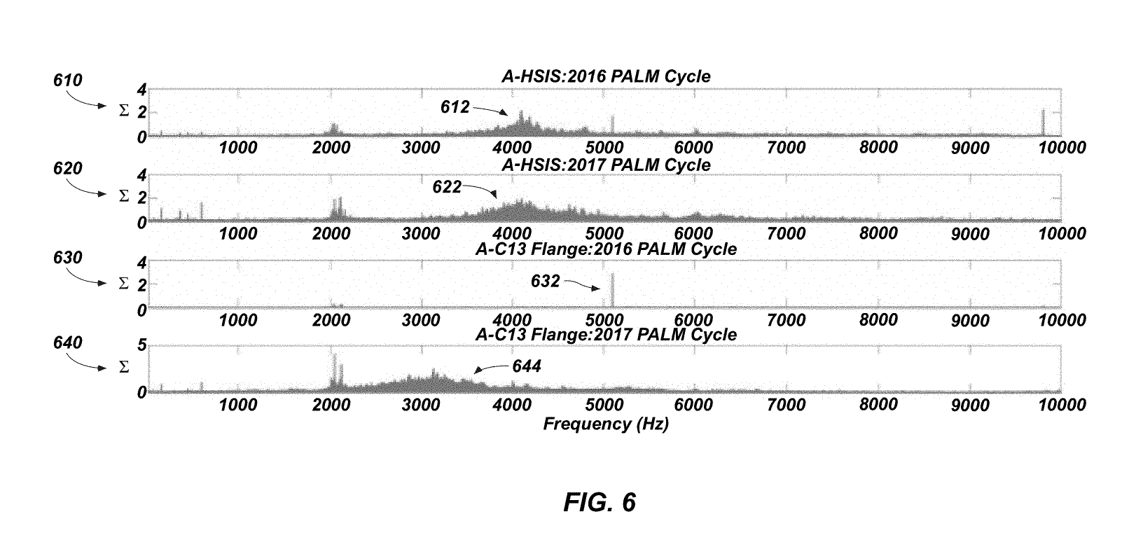

As another example, FIG. 6 shows FFT snapshots 610, 612, 620, 622, 630, 632, 640, 644 of signature data generated from different sensors coupled to different external structures of the nuclear reactor for different usage cycles. Snapshot 610 and snapshot 620 are captured by the same acoustic sensor at the same location (A-HSIS) during a Power Axial Locator Mechanism (PALM) Cycle one year apart for comparison. Snapshot 630 and snapshot 640 are captured by the same acoustic sensor at the same location (A-C13 Flange) during a PALM Cycle one year apart for comparison.

Returning again to FIG. 3, during real-time analysis, the FFT applied to the digitized acoustic data (operation 320) to determine the frequency bands of interest may be converted into an STFFT performed over a selected time interval (T) of the digitized data to determine the frequencies present (operation 330). From the STFFT data, one or more harmonic frequencies may be selected to monitor over time along with the corresponding amplitude phase, and frequency. The STFFT involves a recursive step to generate the output data by shifting a time interval by a percentage (X %) of the duration of the time interval, applying the FFT within the STFFT process to the data within the shifted time interval, recording the amplitude, frequency, and phase of the harmonic frequency selected to be monitored, and determining whether the data have changed over time over the shifted time intervals. Selection of the starting window size T is based on desired frequency accuracy and frequency stability of the signal from the process being monitored. A noisy or shifting harmonic frequency is counter to frequency accuracy. As a starting point, a time window that is a multiple (e.g., 10×) of the time period for the frequency harmonic of interest (e.g., the time window contains at least 10 frequency cycles) can be used. The window size can then be adjusted. For example, if the process being monitored is expected to be very dynamic and have a fast change rate, a smaller time window may be more appropriate. If a stable signal is expected, a longer time window may be more appropriate. As a result, the time window size may be adjusted accordingly depending on the process being monitored. In addition, selection of the percentage (X %) to shift the time window (T) for recursively applying the FFT within the STFFT process can be varied. For example, a 10% shift may be used initially and then adjusted based on the dynamics of the application baseline signal. The amplitude of the selected harmonic frequency for each recursive iteration is recorded to generate a spectrogram that may be displayed for review.

In the exemplary application of the ATR reactor, the nuclear reactor runs with two primary coolant pumps that generate two frequency frequencies caused by the rotating vanes with in the pumps. The nominal frequencies of the two pumps are at 148.3 Hz. The center frequencies from the two pumps are different by fractions of Hz and can vary. The frequency difference between the two slightly different pump frequencies cause an amplitude modulation of the 148.3 Hz fundamental frequency shown in FIG. 5. Thus the amplitude data from the STFFT can be recursively placed into the STFFT process again and provide information and insight on the behavior of the beating pump frequencies.

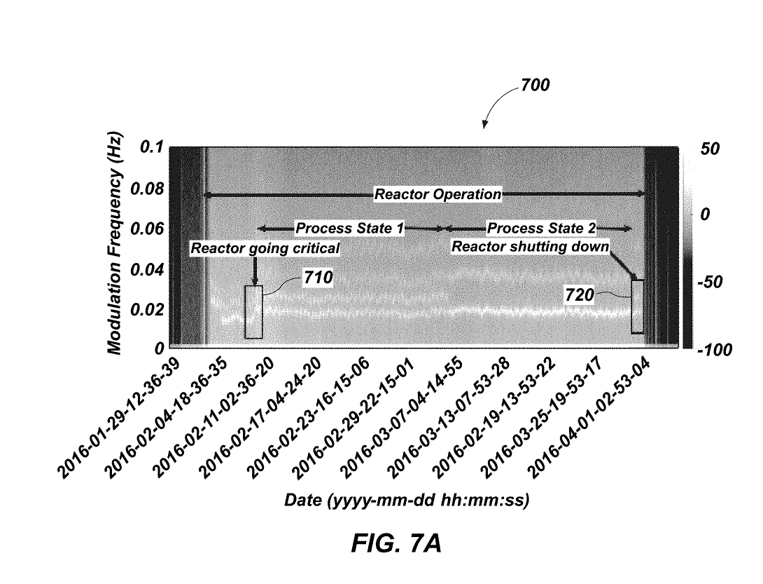

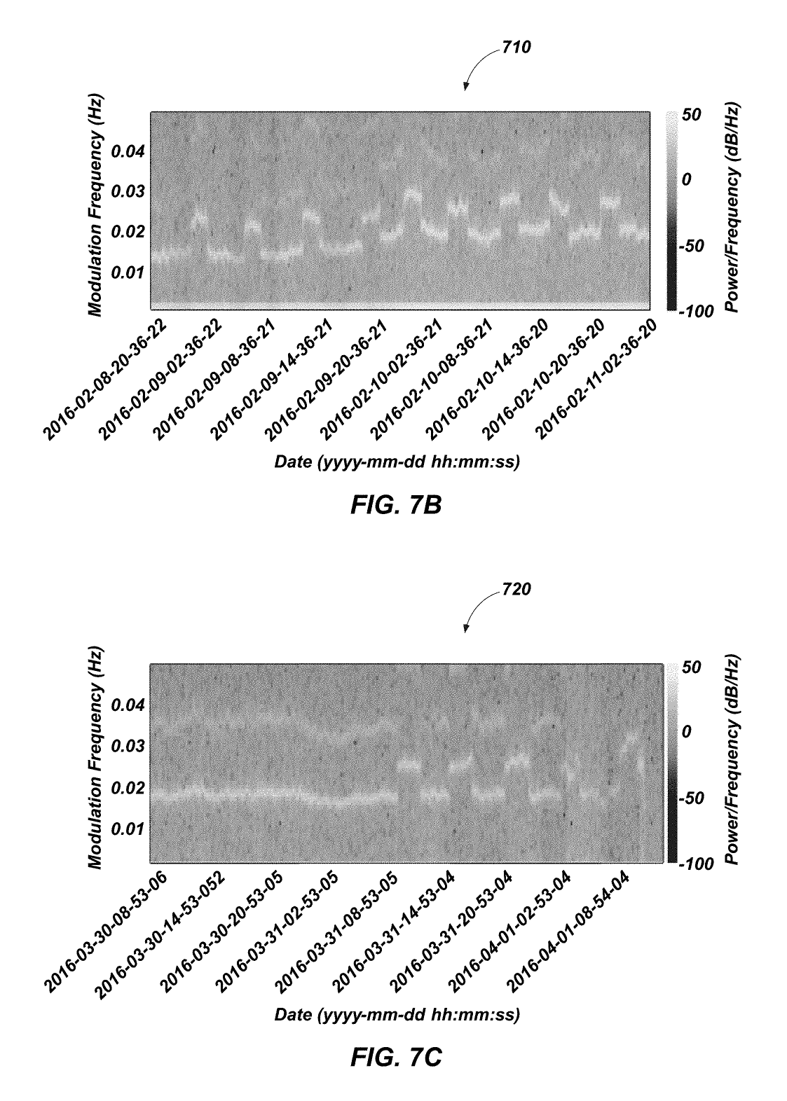

FIGS. 7A-7C are recursive STFFT spectrograms 700, 710, 720 for an operational time scale collected by the AMI. FIG. 7B is a zoomed-in version of box 710 of FIG. 7A for the time period of the nuclear reactor producing power (“goes critical”), and FIG. 7C is a zoomed-in version of box 720 of FIG. 7A for the time period of the nuclear reactor shutting down. The square wave data shows the acoustic data from the recursive STFFT showing the frequency difference between the two pumps change on a periodic basis, which enables the AMI system to draw inferences to the operational conditions of the nuclear reactor over time.

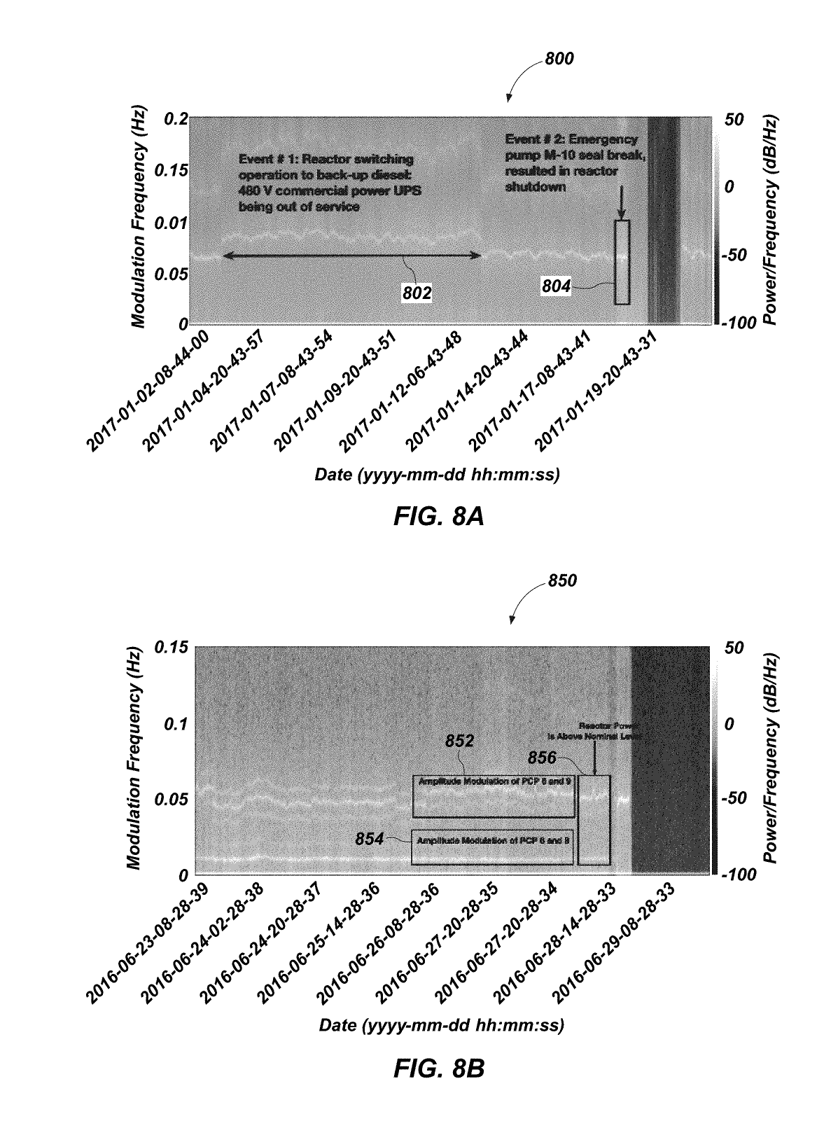

FIGS. 8A and 8B are recursive STFFT spectrograms 800, 850 for an operational time scale collected by the AMI demonstrating a change of state during operation of the nuclear reactor that is detected by the AMI system. Referring to FIG. 8A, during event 1 (indicated by line 802), the modulation frequency of the recursive STFFT increases while the reactor switched operation from a 480 V commercial power UPS to a back-up diesel generator. During event 2 (indicated by box 804), an aberration in the acoustic signature output of the recursive STFFT detected a seal break for an emergency pump that ultimately resulted in a reactor shutdown. This detection through the AMI system occurred prior to detection by a conventional logging system, which results in improved error detection and safety procedures. Referring to FIG. 8B, two distinct modulation frequencies formed by the two beating pumps are indicated at 0.01 Hz (box 854) and 0.05 Hz (box 852) that is the result of three different pumps being operated. Box 856 indicates that the reactor power has increased to above a nominal level due to some aberration within the nuclear reactor. Monitoring and analysis of other operational states of nuclear reactors is also contemplated.

### Example: Advanced Test Reactor

In preparation for using telemetry within the ATR, the ATR may be characterized for acoustic background signatures. To characterize the nuclear reactor, the periodic pressure pulses from multiple (e.g., 5) pump vanes attached to the rotating shaft of the primary coolant pump makes an excellent acoustically telemetered signal source. While simultaneously providing an opportunity for diagnostic and prognostic monitoring of the pumps and motors, the frequency harmonics generated by the pump vanes are nearly identical to signals that would be telemetered by thermo-acoustic sensors inserted into the nuclear reactor core. The telemetered pump signals allow the salient measurement parameters of an actual thermo-acoustic sensor signal, frequency, amplitude and phase, to be understood and characterized.

The sinusoidal signals generated by the pump vanes are processed by using the STFFT (i.e., essentially a sliding-average FFT). The frequency of the largest amplitude spectral component may be monitored and provides dynamic frequency, amplitude, and phase information. The amplitude of the maximum spectral component may be the monitoring focus.

An example of the processed signal is shown in FIG. 5. Note that the amplitude of the pump vane harmonic at 148.3 Hz is amplitude modulated. There is destructive interference from the two pumps that are running at slightly different frequencies. The interference is the same phenomena a passenger hears in a two propeller plane. The sounds from the two engines interfere and the passenger hears a low frequency tone that grows and dies periodically.

This signal is hard to interpret as over long time scales the amplitude modulation looks like noise and obscures detailed signal dynamics. The short time STFFT can be used recursively. The recursive use of the STFFT on the pump harmonic immediately provides information on the process states of the ATR reactor. When there are no pumps running, the signal at 148.3 Hz has no energy and indicates no pumping. The process state of the ATR may be dynamically changing when both pumps are operating.

Dynamic process states of the ATR reactor may result in sharp changes in frequency that can be attributed to process changes. The telemetered signal is detectable despite the multiple coolant inlets and outlets as well as dynamic fluid flow within the nuclear reactor. The telemetered signal may be consistently above the noise floor by over a factor of 2. Data from long term runs show that the two pumps never completely synchronize but the two harmonic frequencies may become stable which will produce a single stable amplitude modulation or beat frequency.

### Example: Thermo-Acoustic Discrimination of Temperature and Elongation in Fuel Rods

Distinguishing between elongation and temperature effects in nuclear fuel rods can also be made. Small changes in both the temperature of the fuel rod and the overall rod length can be detected accurately using a unique acoustic signature, a self-powered acoustic generator, inherently wireless communication, and an analysis method that decouples and simultaneously determines both temperature and elongation changes from two resonant frequencies within the cavity that are anharmonic.

Two measurement parameters (temperature and geometry of the fuel rod) may be tied together when using an anharmonic thermo-acoustic resonator. Both parameters may produce a shift in the resonant anharmonic frequencies that would be monitored. The anharmonic frequencies can be used to decouple the temperature and elongation parameters and distinguish between them. The frequency shifts caused by either temperature changes or elongation changes can be distinguished from one another. This distinction can be used for accident safety monitoring.

A model using standard wave equations describes the wave behavior for a resonator and detector system. The frequency relationship between two anharmonic frequencies was derived from the standard wave equations governing a quarter wave resonator, which showed that the temperature and length of a resonant cavity are separable by using higher order anharmonics. The relative frequency is a function of both the temperature and length of the resonant cavity. By performing a calibration with respect to the length at a fixed temperature, and a calibration with temperature at a fixed length, and monitoring the frequency response of at least two anharmonics, the temperature and length may be measured independently for a deployable system.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure. Further, embodiments of the disclosure have utility with different and various detector types and configurations.

1. A method of operating sensors on or within a system, the method comprising: continuously capturing analog signal data from at least one sensor and digitizing the signal data; applying a Short Time Fast Fourier Transform (STFFT) to the digitized data within a selected time
interval having a duration (T) to obtain a time-frequency spectrum;
selecting at least one harmonic frequency to monitor from the time-frequency spectrum;
recording an amplitude, frequency, and phase for the selected frequency from the time-frequency spectrum;
applying the STFFT to the digitized data within a shifted time interval having a duration (T) and shifted by a percentage (X %) of T;
recording an amplitude, frequency, and phase of the at least one harmonic frequency selected to be monitored from the time-frequency spectrum for the shifted time interval; and
determining whether the analog signal data have changed and whether a condition is causing the analog signal data to change responsive to monitoring the amplitude, frequency, and phase data from the shifted time interval and the amplitude, frequency, and phase data for the previous time intervals.

2. The method of claim 1, wherein the system comprises a nuclear reactor core, and further comprising placing a plurality of sensors generating the analog signal data at different locations on or within the structure of the nuclear reactor core.

3. The method of claim 1, further comprising:
recursively applying the STFFT by using an output from a previous STFFT and performing another
STFFT and obtain additional amplitude, phase and frequency data; and
determining whether the recursive analog signal data have changed and whether a condition is causing the recursive analog signal data to change responsive to monitoring the amplitude, frequency, and phase data from the shifted time interval and the amplitude, frequency, and phase data for the previous time intervals.

4. The method of claim 1, further comprising multiplexing outputs from the plurality of sensors for processing by a single receiver.

5. The method of claim 1, further comprising Fast Fourier transform (FFT) applied to the digitized signal data to obtain a baseline frequency spectrum.

6. The method of claim 5, further comprising determining a harmonic to monitor within the baseline frequency spectrum.

7. The method of claim 6, wherein the harmonic selected to be monitored is a fundamental harmonic.

8. The method of claim 1, wherein the at least one harmonic frequency selected to monitor is the frequency with the largest amplitude.

9. An acoustic measurement infrastructure (AMI) system, comprising:
at least one sensor; and
a data acquisition system including a processor operably coupled to the at least one sensor, the processor configured to:
acquire analog signal data from at least one sensor;
digitize the analog signal data;
convert the digitized analog signal data to obtain frequency information for the digitized signal data;
select at least one harmonic frequency to monitor from the frequency information;
record an amplitude, frequency, and phase for the selected frequency from the frequency information;
apply an STFFT to the raw digitized data within a shifted time interval having a duration
(T) and shifted by a percentage (X %) of T;
record an amplitude, frequency, and phase of at least one harmonic frequency selected to be monitored from the time-frequency spectrum for the shifted time interval; and
determine whether the analog signal data have changed and whether a condition is causing the analog signal data to change responsive to monitoring the amplitude, frequency, and phase data from the shifted time interval and the amplitude, frequency, and phase data for the previous time intervals.

10. The AMI system of claim 9, wherein the processor is further configured to create and store an event log to maintain a list of system events that have occurred for a system data acquisition session.

11. The AMI system of claim 9, wherein the at least one sensor includes at least one of an acoustic based sensor, an electromagnetic based sensor, or an intrinsic sensor configured to generate a signal derived from pressure pulses of a component.

12. The AMI system of claim 9, wherein the processor is further configured to recursively apply the STFFT to the previous STFFT amplitude, phase, or frequency outputs within a shifted time interval having a duration (T) and shifted by a percentage (X %) of T.

13. The AMI system of claim 9, further comprising an electronic display operably coupled with the processor, wherein the processor is further configured to display results of the STFFT to the digitized data on the electronic display.

14. The AMI system of claim 9, further comprising a memory device operably coupled with the processor, wherein the STFFT results are stored in a file in the memory device.

15. The AMI system of claim 9, wherein the processor is further configured to:
apply an STFFT to the digitized data to generate a baseline spectrum; and
compare a subsequent STFFT of the digitized data to the baseline spectrum to determine a deviation therefrom.

16. The AMI system of claim 15, wherein the processor is further configured to control an operational feature of a nuclear reactor responsive to determining the deviation.

17. The AMI system of claim 15, further comprising a memory device operably coupled with the processor, wherein the STFFT results are stored in a file in the memory device.

18. The AMI system of claim 9, wherein the at least one sensor is configured to detect signals generated internally within a nuclear reactor selected from the group consisting of transmission of fluids and moving/vibrating mechanical structures.

19. The AMI system of claim 18, wherein the condition is at least one of a temperature, a neutron flux, a gamma flux, an axial extension of a structure, a fuel-dimension change, or fission gases within the nuclear reactor.

20. The AMI system of claim 18, wherein the at least one sensor is coupled to an external structure of the nuclear reactor selected from the group consisting of a pressure vessel, vessel piping, a flange, and a hydraulic shuttle irradiation system.
